(19) United States
(12) Patent Application Publication
(10) Pub. No.: US 2016/0146258 A1
(43) Pub. Date: May 26, 2016

(54) Exterior Gland and Seal for Submerged Swivel Joint or Rotary Union

(71) Applicant: Bradley T. Martin, Auburn, CA (US)

(72) Inventor: Bradley T. Martin, Auburn, CA (US)

(21) Appl. No.: 14/803,086

(22) Filed: Jul. 19, 2015

Related U.S. Application Data
(60) Provisional application No. 61/999,260, filed on Jul. 22, 2014.

(51) Int. Cl. F16D 1/12; F16C 11/04

(52) U.S. Cl. CPC F16D 1/12; F16C 11/04

(57) ABSTRACT

A fabricated metal gland that incorporates an elastomeric ring and weld to seal and compress a wear ring and o-ring to face-seal two inner and outer rotating bodies. The gland with face seal isolates the area leading to inner machined surfaces created where the inner and outer bodies fit into each other. This seal is particularly useful when rotary unions and swivel joints are submerged for prolonged periods in corrosive mediums. It prevents seizure, and premature wear of seal grooves which leads to loss of lubrication and bearing failure. An added benefit is the original seal becomes a backup seal, increasing longevity of the component:

This application claims the benefit of U.S. Provisional Application No. 61/999,260, filed Jul. 22, 2014.

References Cited
U.S. Patent Documents

| | | | |
|---|---|---|---|
| 3,848,900 | September 1974 | Brundage | U.S. Cl. 285/98 |
| 5,538,296 | July 1996 | Horton | CPC. F16L27/0824 |
| 4,819,999 | March 1989 | Livesay et al. | U.S. Cl. 305/11 |
| 6,901,955 | June 2005 | Valentiane | U.S. Cl. 137/580 |
| 7,117,961 | October 2006 | Yong et al. | U.S. Cl. 175/371 |
| 7,891,711 | February 2011 | Song | CPC. F16L19/06 |
| 14/064,624 | April 2015 | Chapin et al. | CPC. F16J15/344 |

Foreign Patent Documents

| | | | |
|---|---|---|---|
| 6,086,112 | July 2000 | Schofield et al. | Int'l Cl. F16L27/08 |
| 12/975,612 | June 2012 | Vik | Int'l Cl. F16J1534 |

### BACKGROUND OF INVENTION

1. Field of Invention

My invention is a seal with containment assembly that is an “add on” that can be applied to the exterior of rotary unions, swivel joints, or pumps, which undergo prolonged periods of time in corrosive, submerged environments. It protects exposed machined surfaces that contain the seals and bearings, which if compromised can inhibit the rotation of the above and have serious consequences for dependent operations.

2. Related Art

U.S. Pat. No. 3,848,900, was a partial solution to the corrosion problem listed above by using a four-piece sandwich face seal which isolated the machined surfaces of the swivel joint. The deficiencies of this invention are related to the compression of the annular Viton ring by a hose clamp to initiate sealing and a steel washer for its containment. Due to the assembly's open nature and product contact, the hose clamp and steel washer could degrade over time and leave the seal assembly susceptible to leakage. At issue, also, is the Teflon member that had to be thin enough to conform to irregularities of the swivel joint. In tests of my invention, I have found that the Teflon ring between the two Viton seals is the point where wear occurs; therefore, it needs to be robust.

### Summary of Invention

My seal assembly addresses the above deficiencies by using a metal torus gland with a machined recess that contains an annular elastomeric seal which extends from the metal gland to give adequate compressive force to a wear ring that transmits the force to an elastomeric O-ring seated in a groove in the face of the outer swivel joint body. The necessary compressive force is accomplished by the positioning of the torus gland and seal welding it on the inner swivel joint body's outer end; thus creating a durable seal covering the inner and outer swivel joint bodies inner exposed space, and isolating their machined surfaces, allowing unrestricted rotation of the assembly.

### BRIEF DESCRIPTION OF DRAWINGS

FIG. 1 shows the swivel joint in an isometric view with the seal assembly in exploded view.

FIG. 2 shows a front view of the swivel joint and seal assembly with the indicated sectional view.

### DETAILED DESCRIPTION OF THE INVENTION

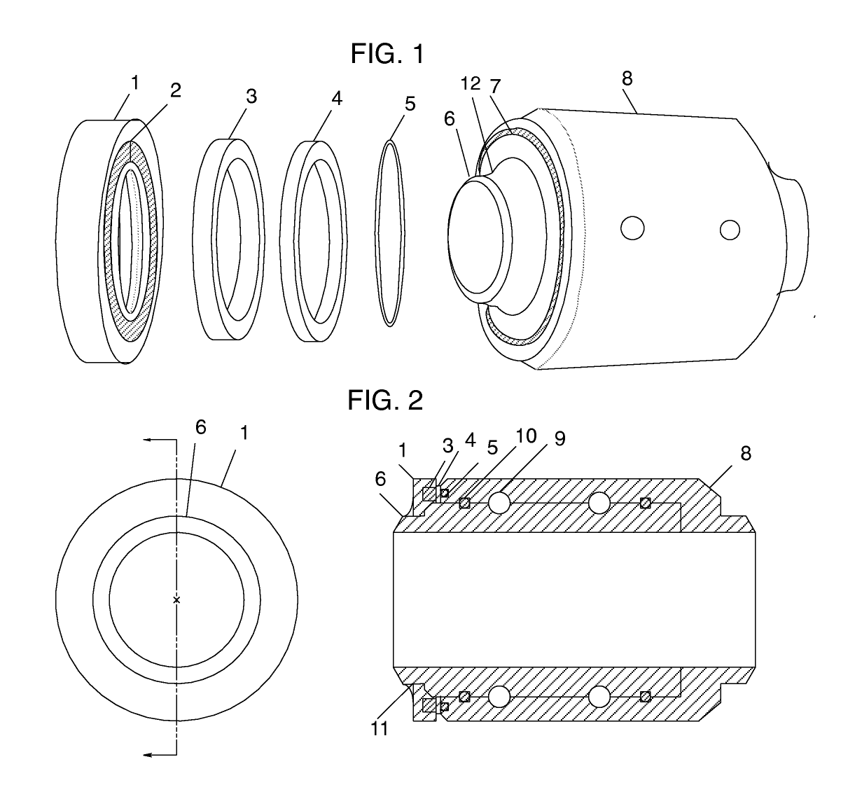

FIG. 1, 12 is the entrance to the space between the machined surfaces of the inner and outer swivel joint bodies 6 8 that leads to O-ring FIG. 2,10 that my invention protects. If entrance FIG. 1, 12 is left exposed, the corrosive medium will enter the space causing deterioration of the machined surfaces causing O-ring FIG. 2, 10 to fail, causing contamination of the grease and precipitating the failure of bearings 9.

As shown in FIG. 2, 1 3 4 5 my invention addresses the above problem by isolating the entry area FIG. 1, 12. This is accomplished by utilizing a metal torus gland 1 with a machined recess 2 to contain and compress elastomeric annular ring 3, translating the compressive force to wear ring 4, which transmits the force to O-ring 5 contained by machined O-ring groove 7, effectively creating a seal between the metal gland 1 and the face of outer swivel body 8. Metal gland 1 is secured in position and joined to the inner swivel body 6 by a circumferential leak-tight weld 11.

The metal gland 1 is made of sufficient material thickness so as not to transmit excessive heat to the elastomeric annular ring 3 during welding and to provide an adequate buffer to corrosion; thus, preventing structural failure. The wear ring 4 may be made from Polytetraflouroethylene, Stainless Steel, or inconel. The wear ring 4 is of sufficient thickness and finish to prevent failure due to abnormal wear and abrading of wear ring 4 and elastomeric seals 3 5. Elastomeric seal material type shall depend on the medium in which my invention is submerged. My invention used “Parker O-Ring Handbook” as a starting point for the development of gland and O-ring groove clearances and tolerances. A specially designed fixture was constructed to test and refine the invention. The last test underwent 45,000 cycles at exterior pressures varying from 15 to 75 psi and at temperatures from 60-100 degrees F.

1. Two cylindrical structures one inside the other creating an inner space between, separated and held in place by bearings so as to allow independent rotation from one another, creating an annular space leading to an exterior;
a.) at the space leading to the exterior created by the two cylindrical structures, an annulus of elastomeric material contained within the outer structure's face to seal;
b.) compressed by an adjacent ring of sufficient thickness and finish to allow rotation and sealing of elastomeric seals;
c.) an adjacent elastomeric annulus.

2. A metal torus which;
a.) Through containment within of the adjacent elastomeric annulus energizes and seals the assembly in claim 1.
b.) By a circumferential weld around its common exterior with the inside structure's exterior end, the space created is sealed and the metal torus' position is secured.
